(19) United States
(12) Patent Application Publication
(10) Pub. No.: US 2008/0309760 A1
(43) Pub. Date: Dec. 18, 2008

(54) METHOD AND APPARATUS FOR CONTROLLING A VIDEO SURVEILLANCE CAMERA

(75) Inventors: Jennifer Joyner, Clovis, CA (US); Robert R. Fahrni, Exeter, CA (US); Endro Kusumo, Fresno, CA (US); Kirsten Medhurst, Fresno, CA (US)

Correspondence Address: PELCO, 3500 PELCO WAY, CLOVIA, CA, 93612, US

(73) Assignee: PELCO, INC., Clovis, CA (US)

(21) Appl. No.: 12/055,469

(22) Filed: Mar. 26, 2008

Related U.S. Application Data
(60) Provisional application No. 60/920,298, filed on Mar. 26, 2007.

(51) Int. Cl. H04N 7/18

(52) U.S. Cl. 348/143; 348/E07.085

(57) ABSTRACT

A method of controlling a video surveillance camera comprising the steps of creating a first camera control to cause the camera to perform one of the control functions from a group of control functions comprising pan, tilt, zoom, and focus, storing the first camera control in memory, providing a video analysis module for analyzing the video images generated by the camera, and associating the first camera control with the video analysis module so that the video analysis module analyzes the video images generated by the camera when the first camera control is implemented.

### CROSS-REFERENCE TO RELATED APPLICATION

This application is related to and claims the benefit of U.S. Provisional Patent Application Ser. No. 60/920,298, filed Mar. 26, 2007, entitled ANALYTICS PROFILE, the entirety of which is incorporated herein by reference.

### STATEMENT REGARDING FEDERALLY SPONSORED RESEARCH OR DEVELOPMENT

N/A

### BACKGROUND OF THE INVENTION

This invention relates generally to surveillance systems and, in particular, to a method and apparatus for controlling a video surveillance camera.

The video surveillance industry has used preset commands which include camera operating parameters, such as pan or tilt position or speed, and zoom or focus setting, to control the camera to move in a predetermined manner at a predetermined time. These preset commands are stored in memory and can, for example, move the camera to a fixed location for a period of time or cause the camera to scan a predefined zone. Even if the camera is not capable of panning or tilting, preset commands have been used, for example, to change the zoom or focus of the camera.

In addition, the video surveillance industry has used software analysis to detect various activities in video images captured by a video camera. The software analysis can include, for example, direction of object movement, object counting, and object removal. However, the industry has felt a long term need for a way to associate specific video image analysis and the configuration and settings of such analysis software modules to a specific preset to allow the users to quickly and easily setup and switch analysis parameters and types of analysis in correlation with the preset camera controls.

### SUMMARY OF THE INVENTION

In accordance with the present invention there is provided a method of controlling a video surveillance camera comprising the steps of creating a first camera control to cause the camera to perform one of the control functions from a group of control functions comprising pan, tilt, zoom, and focus, storing the first camera control in memory, providing a video analysis module for analyzing the video images generated by the camera, and associating the first camera control with the video analysis module so that the video analysis module analyzes the video images generated by the camera when the first camera control is implemented.

In another aspect of the present invention there is provided a video surveillance system comprising a camera for generating video images and having a video analysis module for analyzing the generated video images and a workstation for controlling the camera, the workstation being connected to the camera by a network and having a graphical user interface to enable a user to configure the camera to perform a selected control function from a group of control functions comprising pan, tilt, zoom, and focus and to cause the camera to store the selected control function and to associate the selected control function with the video analysis module so that the camera analyzes the generated video images with the video analysis module when the camera performs the selected control function.

In a further aspect of the present invention there is provided a computer readable medium comprising instructions that, when executed by a computer, cause the computer to be adapted to enable a user to create a first camera control to cause the camera to perform one of the control functions from a group of control functions comprising pan, tilt, zoom, and focus, store the first camera control in memory, provide a video analysis module for analyzing the video images generated by the camera; and associate the first camera control with the video analysis module so that the video analysis module analyzes the video images generated by the camera when the first camera control is implemented.

Other advantages and applications of the present invention will be made apparent by the following detailed description of the preferred embodiment of the invention.

### BRIEF DESCRIPTION OF THE SEVERAL VIEWS OF THE DRAWINGS

FIG. 1 is a block diagram of a video surveillance system utilizing the present invention.

FIG. 2 is a block diagram of an exemplary video source in the video surveillance system shown in FIG. 1.

FIG. 3 is a block diagram of an exemplary workstation in the video surveillance system shown in FIG. 1.

FIG. 4 is an illustration of a graphical user interface utilizing the present invention.

FIG. 5 is a flowchart illustrating one embodiment of the process of the present invention

### DETAILED DESCRIPTION OF THE INVENTION

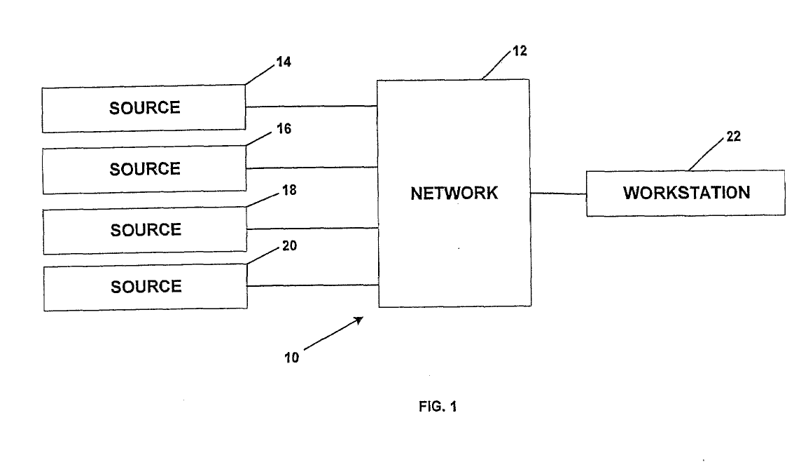

Referring to FIG. 1, a video surveillance system 10 has a network 12 which can be a closed network, local area network, or wide area network, such as the Internet. A plurality of video sources 14, 16, 18, and 20, which can be, for example, video cameras, are connected to network 12 to provide real-time video streams, such as MPEG video streams. Workstation 22, which can be, for example, a control point in surveillance system 10, a personal computer or a user logged into surveillance system 10 by means of a laptop computer, is connected to network 12. Sources 14, 16, 18, and 20 provide MPEG video streams to workstation 22 via network 12.

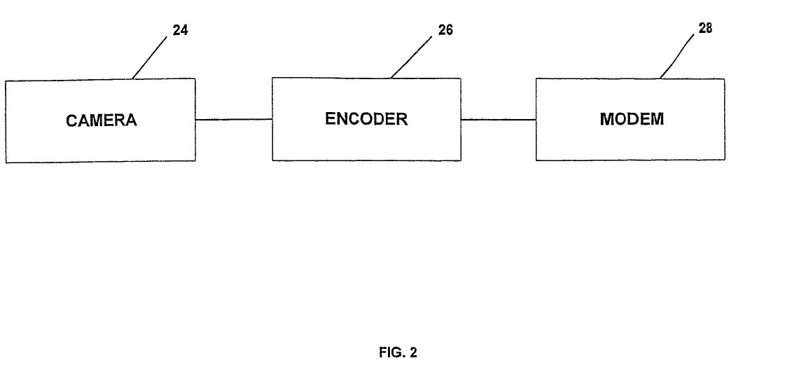

An exemplary video source is illustrated in FIG. 2 in block diagram form. Camera 24 provides its output to encoder 26, which contains a processor and memory. Encoder 26 provides an MPEG video stream to modem 28 for transmitting to network 12. It is to be understood that although camera 24, encoder 26, and modem 28 have been shown as separate devices, their functions can be provided in a single device or in two devices rather than three separate devices as illustrated.

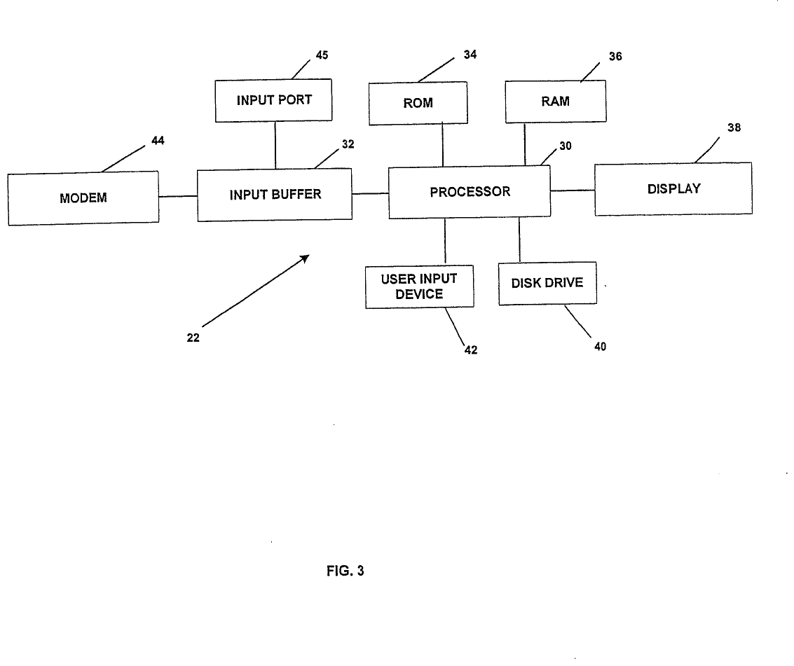

With reference to FIG. 3, an exemplary workstation of the present invention is shown in block diagram form. Workstation 22 has a processor 30 which is connected to input buffer 32, ROM 34, RAM 36, display 38, disk drive 40 and user input device 42. Processor 30 can be a central processing unit or a digital signal processor or both. User input device 42 can be a keyboard, mouse, controller, or other suitable input device. Processor 30 implements algorithms and programs that are stored in ROM 34 or disk drive 40 in response to user input from user input device 42 and provides output signals to display 38. Modem 44 is connected to network 12 and receives the MPEG video streams from sources 14, 16, 18, and 20 in FIG. 1. Modem 44 provides the MPEG video streams to input buffer 32. The video stream data can be stored in a partition of disk drive 40 according to the method of the present invention. Input port 45, which can be, for example, a USB or FireWire port, can also provide video streams to input buffer 32. Alternatively, processor 30 can have its own input buffers, or a portion of RAM 36 can be used as an input buffer.

Encoder 26 can store a number of algorithms in memory for analyzing the video images generated by camera 24. These analytic program modules can detect various behaviors and occurrences in the video images, for example, object counting, directional motion, and the removal of an object. In addition, predetermined commands, for example, pan or tilt position or speed, and zoom or focus setting, can control the camera to move in a predetermined manner at a predetermined time. These predetermined commands, which can be referred to as pattern commands, preset commands, or scan commands, can be stored in camera 24, encoder 26 or another device associated with camera 24. These predetermined commands can, for example, move the camera to a fixed location for a period of time or cause the camera to scan a predefined zone. Even if the camera is not capable of moving, preset commands can be used, for example, to change the zoom or focus of the camera.

The present invention provides a method of creating unique profiles that associate or map the video analytic modules to the camera predetermined commands. For example, if camera 24 is a movable camera, each profile may be based upon a different camera position. The profiles can be stored in encoder 26 and activated manually by a user at workstation 22 or automatically at the appropriate time by a program or script located, for example, in encoder 26 or workstation 22, to trigger these profiles automatically based on a schedule or event. Preferably, the video analysis module is located in encoder 26, and the analysis of the generated video images occurs in encoder 26. User input device 42 provides user input to processor 30, such as instructions for configuring a new profile or interacting with, such as using or modifying, an existing profile.

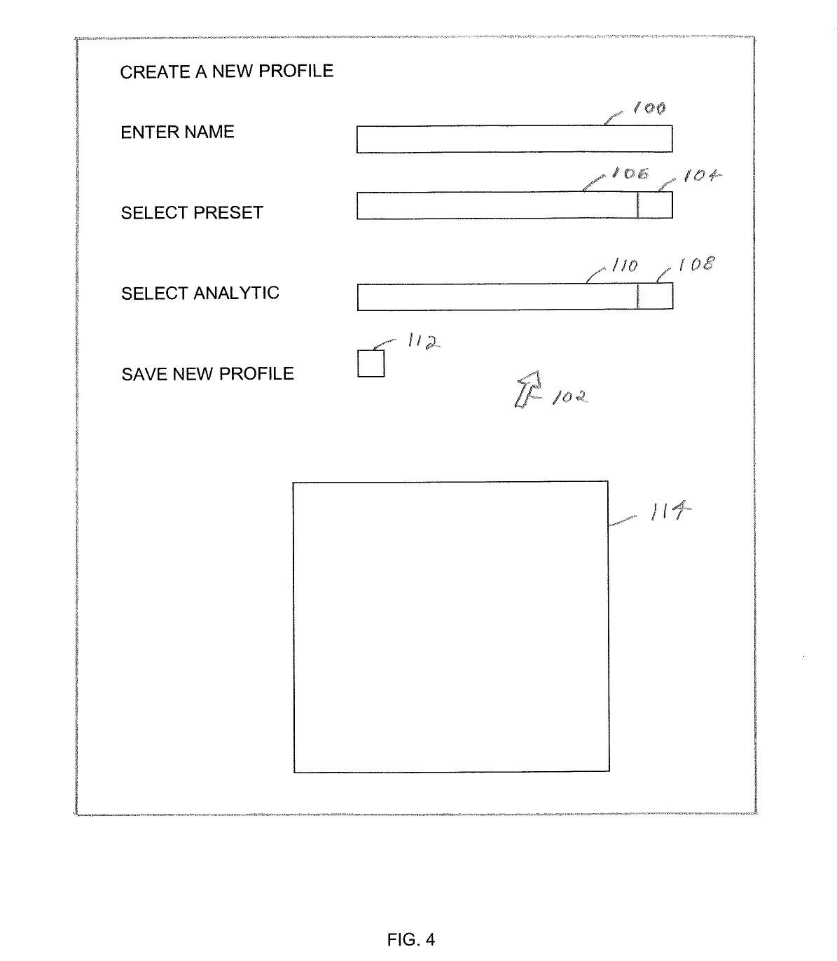

FIG. 4 shows an exemplary illustration of a graphical user interface on the screen of display 38. The graphical user interface in FIG. 4 enables a user to create a new profile and has a box 100 for entering the name of the new profile. A user can create a meaningful, descriptive name for a profile to allow a user to quickly identify the profile, such as an indication of the predetermined command and the video analysis module. An example of a meaningful profile name is “foyer with motion detection”. A user can easily recognize and select the name of the desired profile from a menu on the graphical user interface. By moving pointer 102 with a mouse, a user can activate box 104 to cause a drop down menu from box 106 to display the presets, i.e., the predetermined commands, currently saved for use with the camera being configured by the user. The user can then select the desired predetermined command by using pointer 102 with the drop-down menu from box 106. Similarly, the user can use pointer 102 with box 108 to cause a drop-down menu from box 110 to display the video analysis modules available for use with the camera being configured by the user. The user can then save the new profile by activating box 112 with pointer 102. A window 114 provides the user with a preview of the scene or area that will be monitored by the new profile. The graphical user interface can also provide the user with controls to change the predetermined command, such as to change the pan, tilt or zoom of the camera.

In addition, a user can rename a previously configured profile. A further usability enhancement of the present invention allows a user to create a copy of a profile and save it with a new name. This saves time in configuration, especially if a user wants to retain all the settings from an existing profile but change just one element, such as the object size to be detected or the alarmed direction.

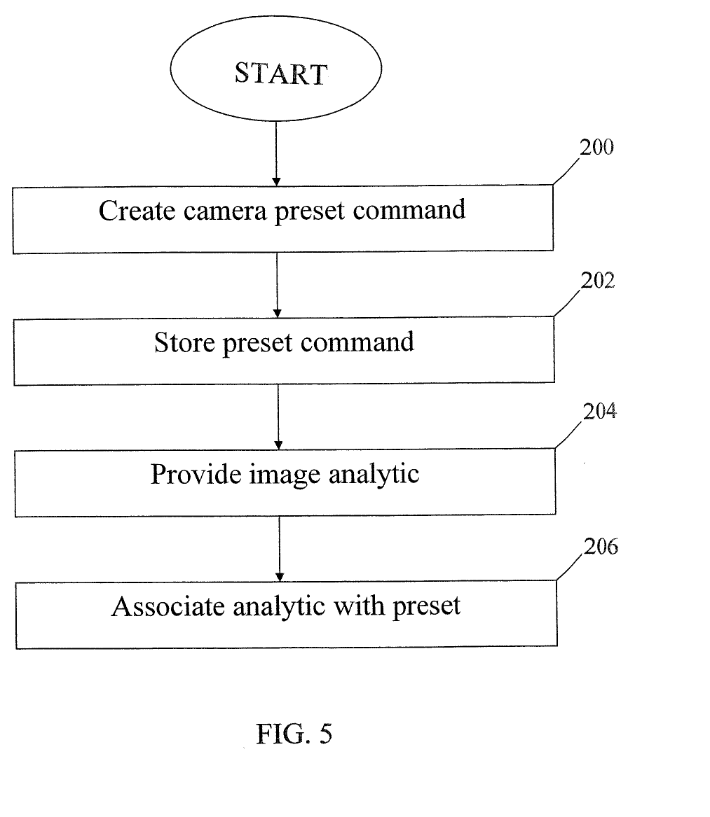

FIG. 5 is a flowchart illustrating a first embodiment of the process of the present invention. At step 200, a camera preset command is created by a user using workstation 22 to configure camera 24 to perform a predetermined command such as to pan to a predetermined location at a predetermined time. This preset command is then stored in camera 24 in step 202. At step 204, an image analytic module adapted to analyze the video images generated by camera 24 is provided by encoder 26. In step 206 a user associates the image analytic in encoder 26 with the preset command in camera 24 so that the image analytic analyzes the video images generated by camera 24 when the preset command is activated or implemented. The association can be accomplished by using workstation 22 to create a profile that is stored in encoder 26.

The video analytic program and configuration and graphical user interface files can be stored separately or together on a computer readable medium, which prefers to any storage device used for storing data accessible by a computer. Examples of a computer readable medium include a magnetic hard disk, a floppy disk, an optical disk, such as a CD-ROM or a DVD, a magnetic tape, a memory chip, and a carrier wave used to carry computer readable electronic data, such as those used in transmitting and receiving e-mail or in accessing a network.

It is to be understood that variations and modifications of the present invention can be made without departing from the scope of the invention. It is also to be understood that the scope of the invention is not to be interpreted as limited to the specific embodiments disclosed herein, but only in accordance with the appended claims when read in light of the foregoing disclosure.

What is claimed is:

1. A method of controlling a video surveillance camera comprising the steps of: creating a first camera control to cause the camera to perform one of the control functions from a group of control functions comprising pan, tilt, zoom, and focus; storing the first camera control in memory; providing a video analysis module for analyzing the video images generated by the camera; and associating the first camera control with the video analysis module so that the video analysis module analyzes the video images generated by the camera when the first camera control is implemented.

2. A method as recited in claim 1 further comprising the step of enabling a user to associate the video analysis module with the first camera control.

3. A method as recited in claim 2 wherein said step of enabling a user to associate the video analysis module with the first camera control comprises enabling a user to interact with a graphical user interface to associate the video analysis module with the first camera control.

4. A method as recited in claim 3 wherein said step of enabling a user to interact with a graphical user interface to associate the video analysis module with the first camera control comprises enabling a user to interact with a graphical user interface on a workstation located remote from the video camera.

5. A method as recited in claim 4 wherein said step of enabling a user to interact with a graphical user interface to associate the video analysis module with the first camera control comprises enabling a user to create a profile to associate the video analysis module with the first camera control and to name the profile.

6. A method as recited in claim 5 wherein said step of enabling a user to create a profile comprises the step of enabling a user to modify the profile.

7. A method as recited in claim 6 wherein said step of enabling a user to create a profile comprises the step of enabling a user to change the name of the profile.

8. A video surveillance system comprising: a camera for generating video images and having a video analysis module for analyzing the generated video images; and a workstation for controlling said camera, said workstation being connected to said camera by a network and having a graphical user interface to enable a user to configure said camera to perform a selected control function from a group of control functions comprising pan, tilt, zoom, and focus and to cause said camera to store said selected control function and to associate said selected control function with said video analysis module so that said camera analyzes the generated video images with said video analysis module when said camera performs said selected control function.

9. A video surveillance system as recited in claim 8 wherein said graphical user interface enables a user to create a profile associating said selected control function and said video analysis module.

10. A video surveillance system as recited in claim 9 wherein said graphical user interface enables a user to modify said profile.

11. A video surveillance system as recited in claim 10 wherein said graphical user interface enables a user to name said profile.

10. A video surveillance system as recited in claim 8 wherein said camera comprises an image generating device and an encoder for encoding the generated video images for transmission over the network to said workstation and wherein said video analysis module is stored in said encoder.

11. A computer readable medium comprising instructions that, when executed by a computer, cause the computer to be adapted to enable a user to create a first camera control to cause the camera to perform one of the control functions from a group of control functions comprising pan, tilt, zoom, and focus, store the first camera control in memory, provide a video analysis module for analyzing the video images generated by the camera; and associate the first camera control with the video analysis module so that the video analysis module analyzes the video images generated by the camera when the first camera control is implemented.

12. A computer readable medium as recited in claim 11 further comprising instructions that, when executed by a computer, cause the computer to be adapted to enable a user to create a profile to associate the video analysis module with the first camera control and to name the profile.

13. A computer readable medium as recited in claim 11 further comprising instructions that, when executed by a computer, cause the computer to be adapted to enable a user to modify the profile and the name of the profile.
